(19) United States
(12) Patent Application Publication
(10) Pub. No.: US 2015/0293548 A1
(43) Pub. Date: Oct. 15, 2015

(54) Grid Level Flywheel Electric Storage System

(71) Applicant: Gerald Frank Simons, Bosque Farms, NM (US)

(72) Inventor: Gerald Frank Simons, Bosque Farms, NM (US)

(21) Appl. No.: 14/248,603

(22) Filed: Apr. 9, 2014

(51) Int. Cl. G05F 1/66

(52) U.S. Cl. CPC G05F 1/66

(57) ABSTRACT

An Electrical Energy Storage system to store power generated at times of surplus availability of power in the grid or wind derived generator and stored as energy in a flywheel for use at times of grid or wind generated power shortage. The system is based upon computer control of power being processed by hydraulic components into storage provided by a conventional flywheel being hydraulically driven and harvested by means of converting hydraulic energy into electrical energy. Energy for storage may be derived from the national electric grid, any renewable energy source, or other electrical source. The energy stored in the flywheel may be harvested and returned to the grid or any other electrical sink.

### CROSS REFERENCE TO RELATED APPLICATIONS

This application claims the benefit of Provisional Patent Application No. 61/853,760

### STATEMENT REGARDING FEDERALLY SPONSORED RESEARCH AND DEVELOPMENT

Not applicable

### BACKGROUND OF THE INVENTION

### Field of the Invention (Technical Field)

The present invention relates to electrical storage systems, specifically electrical storage systems that provide the provisions for stabilization and energy management of the electric grid.

### Brief Summary of the Invention

The embodiment of the present invention is a system comprised of hydraulic, electrical and electronic component parts interconnected to manage the functional capability of a flywheel to control application of flywheel energy storage to provide means to ensure electric grid functional operation.

### BACKGROUND OF THE INVENTION

### Prior Art

Electrical power distributed by the electric grid, for usage by a multitude of users suffers from varying load demand. At different times of the day and seasonally, the load imposed on the generating and distributing networks of the power utilities varies widely. During the daylight hours the demand peaks. During the summer months air conditioning demand peaks. The utility is obligated to service the load at all times. To have that power available requires an enormous waste of resources.

Renewable sources of energy are being exploited but their contribution is limited to times when the sun shines or when the wind blows. A storage system is needed that can store excess energy available at times when the service demand is low. A storage system capable of providing the power to the electrical grid during variations of grid load is desired. The present invention describes a system to store energy that can be scaled in magnitude to provide support for the electrical grid when there is a shortage of available energy or when stabilization is required.

Prior art to resolve the need for electrical storage systems is limited to two general areas. The first is battery storage. It is obvious that there could be enough energy stored in a large battery bank to supply grid service requirements at a substation level. In practice, that is not practical but has been done in cases where grid support is mandatory. Batteries have several distinct disadvantages. They are expensive to buy. They begin to deteriorate immediately when placed in service and therefore must be replaced in a very short time. A typical deep cycle lead acid battery can accept approximately 500 charge-discharge cycles before failure. That limits their life to slightly more than year. They require continuous maintenance and must have a controlled environment, including the capability of venting of gases produced during the recharge operation. Upon having been discharged they can be recharged only at a rate equal to 10% of their storage capacity without suffering damage thus requiring elaborate charging control systems. In some battery types, large discharge currents cause internal heating to the point that the battery explodes. The energy that can be derived from a battery is limited to a small fraction of its storage capability. As an example, a 12-volt lead acid battery may be discharged only until its terminal voltage is 10.5 volts without suffering damage. To discharge it below 9.5 volts destroys the battery. Nickel metal hydride batteries are only slightly better and cost much more. Lithium ion batteries in the large sizes are still undergoing development to make them practical.

The failure mode of batteries is to develop a short circuit between the positive and negative terminal. With a bank of batteries as is required for storage of a practical amount of energy, if one of the batteries in the bank experiences a short circuit, the others of the battery bank deliver enormous current to that short circuit. That current develops sufficient heat to cause the battery to explode with a potential ensuing fire. Not only is there a danger from the explosion, the entire area is exposed to the flying electrolyte, in this case acid. A major personnel and environmental hazard is the result.

There are many other disadvantages relating to battery storage.

Flywheel energy storage is also used but with limited success. Typically the drive and energy harvesting systems are electric motors of some type. Electric motors are unable to exert large starting torques. A flywheel represents a large inertia and for any acceleration, the torque needed to cause its increased rotational speed approaches the stall torque of the driving motor. Currents in an electrical motor are limited by the back voltage generated as the motor rotates within its electric field. When stalled that back voltage is zero and only rises upon rotation of the motor. Thus a stalled, or near stalled motor current reaches enormous magnitude and the motor suffers a heat failure. To accommodate that limitation, the common practice is to reduce the weight of the flywheel and increase its speed. The speed of rotation results in hoop stress that increases exponentially as the speed increases. The resulting flywheel is therefore small, light weight and runs at a high speed limited by its structural hoop stress ability and motor stall characteristics. The energy stored in the flywheel is a function of its moment of inertia that is a function of the square of its radius, thus making the flywheel small reduces its storage capability. To maximize the storage capability and still meet the allowable hoop stress limitation, materials used in flywheels have been improved but still the typical commercially available flywheel stores a minimum, nearly impractical amount of energy.

To harvest the energy of the flywheel electromagnetic coupling is commonly used. As the flywheel speed increases, the frequency of the harvested energy increases along with the magnetic losses such as eddy currents, hysteresis losses and radiated energy at that relatively long wavelength. Ultimately the entire energy recovery system is limited by magnetic saturation. To synchronize the flywheel to the electric grid because of the high frequency of its output is exceptionally difficult.

A major concern with existing flywheels is the danger of explosion that would occur upon a structural failure. Upon failure the flywheel immediately releases all its stored energy. As an example a flywheel that stores 15 kWh of electricity contains the equivalent energy contained in 25 sticks of dynamite. If the flywheel were to fail al that energy is released at once causing an explosion that is the equivalent of 25 sticks of dynamite. By laminating its structure the flywheel of the present invention reduces the possibility of energy release by the proportional mass of its laminated parts. In the case of a 15 kWh flywheel, the instant energy release would approximate 5% of its stored energy.

The present invention overcomes those technical limitations.

Except for the present invention, there is nothing currently available to provide a practical solution to the need for electrical energy storage in a magnitude required to serve the electric grid.

### DRAWINGS

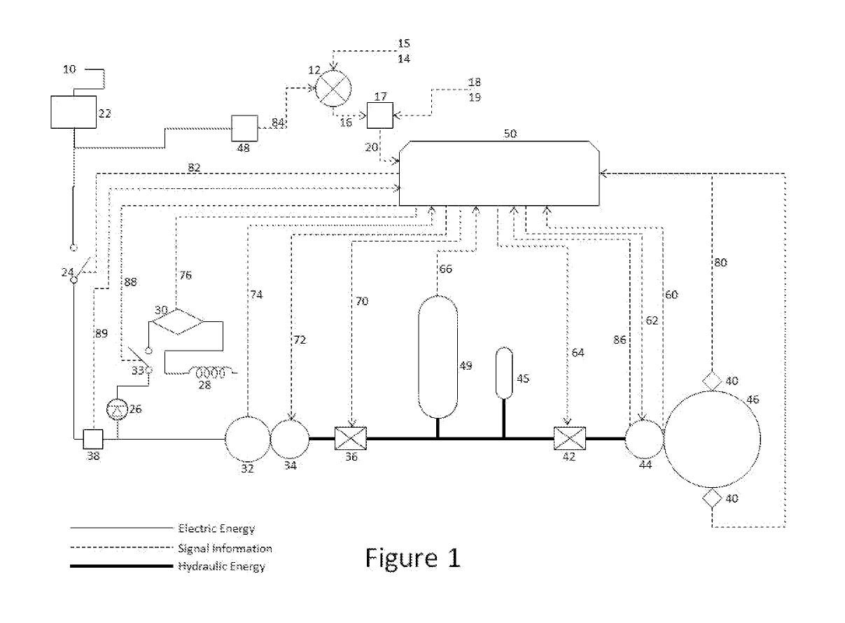

FIG. 1 Grid Energy System Block Diagram
REFERENCE NUMERALS

10 Electric Grid or Win generator output
12 Summing Junction
14 Nominal voltage signal
15 Nominal frequency signal
16 Error signal
17 Threshold
18 Plus threshold signal
19 Minus threshold signal
20 Computer command signal
22 Voltage matching transformer
24 Disconnect switch
26 Rectifier
28 Motor generator field
30 Pulse width modulator
32 Motor Generator
33 Field disconnect switch
34 Motor Generator hydraulic motor pump
36 Motor generator directional control valve
38 Current sensor
40 Vibration sensor
42 Flywheel directional control valve
44 Flywheel hydraulic motor pump
45 Pressure Relief valve
46 Flywheel
48 Signal transformer
49 Accumulator
50 Computer
60 Flywheel speed signal
62 Flywheel motor/pump displacement signal
64 Flywheel directional control valve signal
66 Accumulator pressure signal
68 Grid disconnect switch signal
70 Motor generator directional control valve signal
72 Motor generator motor pump displacement signal
74 Motor generator voltage and frequency signal
76 Pulse width modulator field control signal
80 Vibration signal
82 Disconnect switch control signal
84 Grid or wind generator signal
86 Flywheel Motor Pump pressure drop signal
88 Field disconnect switch signal
89 Motor current

### DETAILED DESCRIPTION

FIG. 1 shows a functional block diagram of the system. It is understood that the form of the electrical power is typically 3 phase with appropriate grounding and neutral conductors. FIG. 1 is a line diagram showing the system functions.

The power level and frequency of the electrical grid serving the US or another segment of the globe varies with the applied load. Further it varies from one region to another. Additionally, the level of power generated by renewable energy systems such as wind farms and photovoltaic arrays depend upon the vagaries of nature. The wind does not always blow nor at the same speed. The sun does not always shine with the same intensity. Power storage or frequency control becomes a necessity in order to maintain a required level of power and the correct frequency to serve the loads

The generators that supply the grid produce power to the grid at a fixed frequency and voltage. Those parameters are controlled by governors on the generators at the power plant supplying power to the grid. If a large instantaneous load is applied to the grid, that causes the available voltage and frequency of the entire grid to decline as a function of the line loss to the power plant as well as causing the rotating speed of the power plant generators to decline, thus lowering the frequency. The governors are not able to respond quickly enough and both the voltage and frequency of the grid decline. Adding power with a response time shorter than that of the power plant governors at discrete location on the grid removes the demand from the power plant generators and the existing governor settings remain at the correct voltage and frequency. Alternatively, if a major load were to be removed, the generators at the power plant would be unloaded and the voltage and frequency would increase. Absorbing that excess capability of the power plant generators with a response time shorter than that of the governors at the power plant provides the needed load to the generator at the power plant to allowing the existing governor setting to remain at the correct voltage and frequency. Additionally there are times when the load demand is less than the existing output of the power plant generators, in which case there is a surplus of power available that is otherwise wasted. At other times there may be more demand than can be supplied by the power plant generators on line in which case additional generators must be immediately started to supplement the deficiency. Having storage that is immediately available to either supplement that grid deficiency or load it to control power surplus as provided by the system of the present invention resolves those grid anomalies.

In the system of the present invention, the instantaneous status of the Electric grid or Wind generator output 10 is measured by use of Signal transformer 48. Grid or Wind generator status signal 84 is transmitted to summing junction 12. If grid frequency is to be controlled, Nominal frequency signal 15 is fed to Summing Junction 12. Alternatively if voltage is the parameter to be controlled, Nominal voltage signal 14 is fed to Summing junction 12.

Grid or Wind generator output status signal 84 provides existing frequency or voltage to the input of Summing junction 12. The output of Summing junction 12 is the difference between the input frequency or voltage signals and their associated nominal values. If Grid or Wind generator status signal 84 is greater than Nominal voltage signal 14 or Nominal frequency signals 15, it indicates an available surplus of power available over and above that which is needed to serve its electrical load, and a part or all of that surplus power may be stored in Flywheel 46. When Electric grid or Wind generator output 10 shows a surplus of available power it will be considered an electrical source. Alternatively if the power status of Electric grid or Wind generator output 10 shows a deficiency in available power to serve its load, part or all of that deficiency may be made up by returning power, which was stored as energy in Flywheel 46 to Electric grid or Wind generator output 10.

The output of Summing junction 12 is Error signal 16. Error signal 16 is presented to Threshold 17. Threshold 17 determines if the error signal being presented from summing junction 12 is of magnitude sufficient to cause an action to initiate.

Plus threshold signal 18 and Minus threshold signal 19 are established by the system operator and determine at what level of error signal in either frequency or voltage action is to commence.

If error signal 16 exceeds Plus threshold signal 18 it indicates that a surplus of power or the frequency of the grid is higher than the magnitude of the established thresholds and action need to be taken to correct that condition. Computer command signal 20 is sent to Computer 50 to take appropriate action.

If Error signal 16 exceeds Minus threshold signal 19 it indicates that a deficiency of power or the frequency of the grid is lower than the magnitude of the established thresholds and action need to be taken to correct that condition. Computer command signal 20 is sent to Computer 50 to take appropriate action

Flywheel 46 is designed to have its major mass at its periphery. It may be supported on conventional bearings and driven in rotation by Flywheel hydraulic motor pump 44. The flywheel assembly is mounted in an essentially airtight cylindrical cavity vented to atmosphere by a check valve. As the assembled flywheel spins within the airtight cylindrical cavity, the air contained within that cavity spins with the wheel. Air has weight and as it spins the air entrapped in the cylindrical cavity is forced to the outer wall of the cavity. Its pressure increases as it is compressed by its rotational force. As the wheel reaches its maximum speed for the first time, most of the entrapped air escapes through the check valve leaving a partial vacuum within the cavity. That partial vacuum reduces the aerodynamic drag on the spinning flywheel.

Computer 50 is a system controller that may be any form of electronic control device. It may be a digital computer capable of being programmed to perform the required functions, a simpler logic control device or analog circuitry. The electronic interface circuitry necessary to configure the control device signals into the proper format for use by the active elements of the system is included with the actions of Computer 50.

The speed of Flywheel 46 is transmitted to Computer 50 via Flywheel speed signal 60. Flywheel hydraulic motor pump 44 is a variable displacement hydraulic motor pump that may function as a motor or pump depending upon the configuration of its ports. In one configuration in which the motor pump is to function as a motor, one of the ports may be connected to the pressure side of the hydraulic system while the other port is connected to the return storage tank. Alternatively if the motor pump is to function as a pump, those two ports are reversed. The amount of fluid that is used as a motor or is pumped as a pump is controlled by its internal displacement, which is varied electrically. That displacement is controlled via Flywheel motor pump displacement Signal 62.

Flywheel directional control valve 42 controls the port configuration of Flywheel hydraulic motor pump 44. If the system application requires that no stored energy be derived from Flywheel 46, Flywheel hydraulic motor pump 44 is configured by Flywheel directional control valve 42 to a configuration that blocks the pressure and return ports and interconnects the two ports of Flywheel motor pump 44. Via Flywheel motor pump displacement signal 62 the displacement of Flywheel motor pump 44 is set at a minimum. In that configuration the output fluid from the motor pump, if any, is connected to its input and the entrapped fluid simply recirculates at a minimum level creating essentially no load on the driving energy source. That configuration is labeled ‘Standby’.

If energy is to be derived from Flywheel 46, Flywheel motor pump 44 is configured by Flywheel directional control valve 42 to function as a pump and pump hydraulic energy into the system ultimately increasing the power level of the grid or wind generated output. If energy is to be added to the storage level of Flywheel 46, Flywheel directional control valve 42 configures Flywheel hydraulic motor pump 44 to function as a motor. Hydraulic energy derived from the system is fed to Flywheel hydraulic motor pump 44 causing the speed of Flywheel 46 to increase thus storing the added energy in Flywheel 46.

Accumulator 49 is a hydraulic/pneumatic accumulator having within it a section containing inert gas separated from the hydraulic fluid it contains by a flexible membrane. As the hydraulic pressure varies, the inert gas is compressed or decompressed as a function of system pressure.

The pressure existing within Accumulator 49 is transmitted to Computer 50 via Accumulator pressure signal 66.

To process grid level power into energy to be stored in Flywheel 46 or take energy out of Flywheel 46, Motor generator 32 is employed. Motor generator 32 derives power from Electric grid or Wind generator output 10 or delivers power to Electric grid or Wind generator 10. Voltage matching transformer 22 matches the voltage requirements of the system to the voltage of the Electric grid or Wind driven generator output 10.

In the event that power is to be derived from Electric grid or Wind generator 10 for energy storage in Flywheel 46, Motor generator 32 receives power from Disconnect switch 24. Disconnect switch 24 is a solid-state switch capable of handling the power being transmitted within the system and whose configuration is controlled by Disconnect switch control signal 82. Disconnect switch 24 consists of three separate switches, each one independently switching a phase of the three phase power system. If power is to be derived from Electric grid or Wind generator output 10, with Disconnect switch 24 closed, power from Electric grid or Wind generator output 10 is fed to Motor generator 32. Motor generator 32 may be an AC wound rotor motor generator whose fields are excited by DC when Field disconnect switch 33 is closed. The level of field excitation is established by Computer 50 using a pulse width modulator electronic circuit. Power (voltage and current) is presented to the pulse width modulator electronic circuit. The circuit reduces the input voltage into square waves. By varying the width of the square wave the input voltage is reduced by the ratio of on time to off time of the square wave—thus modulating the input power according to the width of the wave or pulse. Therefore, the pulse width modulator electronic circuit is capable of delivering variable voltage power to the field of Motor generator 32. Pulse width modulator/field control signal 76 is fed to Pulse width modulator 30 to control the level of excitation of Motor Generator field 28. AC current supplied by Motor Generator 32 is rectified by Rectifier 26 and processed by Pulse Width modulator 30 as DC to excite the field of Motor Generator 32.

If power is to be delivered to Electric Grid or Wind generator output 10, Motor generator 32 would function as an electrical generator to provide power to Electric grid or wind generator output 10. In order to drive Motor generator 32 as a generator, Motor Generator hydraulic motor pump 34 is configured by Motor generator directional control valve 36 to cause Motor Generator hydraulic motor pump 34 to function as a motor. Motor generator 32 delivers power to Disconnect switch 24 and Voltage matching transformer 22 and thus to Electric grid or wind generator output 10. The magnitude of the power being delivered is controlled by Computer 50 in response to Grid or Wind generator output status signal 84. The magnitude of the power being delivered to Electric grid or Wind generator output 10 is controlled by the excitation of Motor generator field 28. That excitation is provided by Pulse width modulator 30. The amount of power delivered to Electric grid 10 is controlled by the magnetic strength of Motor generator field 28. The level of power and its frequency that is being generated by Motor generator 32 is fed to Computer 50 by Motor generator output signal 74.

The frequency of the AC power being fed to Electric grid and Wind generator output 10 from Motor generator 32 must match the frequency of Electric grid and Wind driven generator 10. To make the frequencies match, Computer 50 via Motor generator motor pump displacement signal 72 alters the speed of Motor Generator hydraulic motor pump 34 thus altering the speed of Motor generator 32 as necessary to cause the output frequency of Motor generator 32 to match that of Electric grid and Wind generator output 10.

A circumstance could arise in which there was no requirement to either derive energy from Electric grid and Wind generator output 10 or to provide energy to Electric grid or Wind generator output 10 or Flywheel 46 was at full speed and could accept no more energy. In that event Motor generator directional control valve 36 would be configured so that it blocks the pressure and return ports and interconnects the two ports of Motor Generator hydraulic motor pump 34. Via Motor generator motor pump displacement signal 72 the displacement of Motor Generator hydraulic motor pump 34 is set at a minimum. In that configuration the output fluid from the motor pump is connected to its input and the entrapped fluid simply recirculates at a minimum level creating essentially no load on the driving energy source. That configuration is labeled “standby”.

### FUNCTIONAL DESCRIPTION OF THE PREFERRED EMBODIMENT

The electric grid of the US or other geographic area serves thousands of customers and covers the entire lower 48 states of the United States and Canada. Similar grids are in place in countries around the world. As power is demanded by customers in varying levels and at varying times, the electric grid becomes unbalanced in that there is more demand in one section of the grid than in another. In that case power is transported from area to area. Within an area, power demand also fluctuates. There is no immediate method available whereby that local grid can be stabilized and as a result, voltage varies across the grid and varies from minute to minute, even second to second. At this time there is no means available to the operators of the grid to ameliorate that problem. The present invention provides a method of local control to respond to that need.

Renewable energy may be supplied to the grid by the use of wind generators. The generators derive power from rotating blades of a windmill connected through a drive mechanism that controls the speed and therefore the frequency of the output of an electrical generator. The output of the generator is synchronized with the grid and when capable, supplies power to the grid. At times there is a surplus of wind power and at other times the available wind power is insufficient to support the grid.

The system of the present invention provides means to store surplus energy of the grid and wind derived power at a time when it is available, hold that storage as long as desired by the grid system operator and return it to the grid when needed. Accordingly the system can be configured in three separate configurations. It may be configured to collect grid or wind generator output surplus energy. That is called the flywheel-charging mode. It may be configured to hold the level of energy that it has stored. That is called the Standby mode or it may be configured to return its stored energy to the grid. That is called the Flywheel discharging mode.

Assume a grid status such that at the local level the condition of the grid is momentarily at a nominal frequency and or voltage. That condition requires neither supplemental external input nor output power. The configuration of the components of the system when functioning under the circumstance of no external power transfer is labeled the “Standby” mode.

Further assume that the system of the present invention is in place.

Signal transformer 48 measures the status of Grid and wind generator output 10. That status level is transmitted to Summing junction 12 by Grid and Wind generator output status signal 84. If frequency is to be controlled, Nominal frequency signal 15 is present at summing junction 12. If voltage is to be controlled Nominal voltage signal 14 is present at summing junction 12. With no requirement for power transfer, Grid and Wind generator output status signal 84 is equal to Nominal frequency signal 15, in the case if frequency control or Nominal voltage signal 14 in the case of voltage control, Error signal 16 is zero and falls within Plus threshold signal 17 and Minus threshold signal 18. No Computer command signal 20 is generated and the system remains in “Standby.”

Disconnect switch 24 and Field disconnect switch 33 are closed. Excitation to Motor generator field 28 is nominal as directed by Pulse width modulator/field control signal 76. Since no power is to be transported within the system, Motor generator 32, running on power presented to it via Voltage matching transformer 22 and Disconnect switch 24 requires a minimum amount of power from Grid and wind generator output 10. It is necessary that Motor generator 32 be operating at near normal speed so that when it becomes necessary for it to contribute to the transport of power within the system it is up to speed and requires minimum time to become functional.

In order to minimize the load on Motor generator 32, Motor Generator hydraulic motor pump is placed in “standby”. Motor generator directional control valve 36 blocks the input and output pressure ports and has configured Motor generator hydraulic motor pump 34 to connect the input and output ports and to set the displacement at zero. No fluid is being pumped and Motor generator hydraulic motor pump 34 is providing essentially no load to Motor generator 32.

Meanwhile flywheel 46 is spinning, driving Flywheel hydraulic motor pump 44. Flywheel motor pump 44 is placed in “standby’. The entire system is now in standby. Flywheel directional control valve 42 has blocked the input and output pressure ports and configured Flywheel hydraulic motor pump 44 to connect the input and output ports and to set the displacement at zero. No fluid is being pumped and Flywheel hydraulic motor pump is providing essentially no load to Flywheel 46.

Assume that there is a surplus power shown by Grid and Wind generator output status signal 84 that provides existing frequency or voltage to the input of Summing junction 12. The output of Summing junction 12 is the difference between the input frequency or voltage signals and their associated nominal values. If Grid or Wind generator signal 84 is greater than Nominal voltage signal 14 or Nominal frequency signals 15, it indicates an available surplus of power available over and above that which is needed to serve its electrical load, and a part or all of that surplus power may be stored in Flywheel 46. When Electric grid and Wind generator output 10 shows a surplus of available power it will be considered an electrical source. Alternatively if the power status of Electric grid and Wind generator output 10 shows a deficiency in available power to serve its load, part or all of that deficiency may be made up by returning power, which was stored as energy in Flywheel 46 to Electric grid and Wind generator output 10.

The output of Summing junction 12 is Error signal 16. Error signal 16 is presented to threshold 17. Threshold 17 determines if the error signal being presented from summing junction 12 is of magnitude sufficient to cause an action to initiate.

Plus threshold signal 18 and Minus threshold signal 19 levels are established by the system operator via a secure data link not part of the present invention, and determine at what level of error signal in either frequency or voltage action is to commence.

If Error signal 16 exceeds Plus threshold signal 18 it indicates that a surplus of power or the frequency of the grid is higher than the magnitude of the established thresholds and action needs to be taken to correct that condition. Computer command signal 20 is sent to Computer 50 to take appropriate action.

If Error signal 16 exceeds Minus threshold signal 19 it indicates that a deficiency of power or the frequency of the grid is lower than the magnitude of the established thresholds and action needs to be taken to correct that condition. Computer command signal 20 is sent to Computer 50 to take appropriate action

If frequency is the parameter under control and Error signal 16 exceeds plus Threshold signal 19 it indicates a frequency that is too high, Computer 50 initiates a program to take action to load the grid thus lowering the frequency.

If voltage is the parameter under control, if Error signal 16 exceeds Plus threshold signal 19 indicating a voltage that is too high, Computer 50 initiates a program to take action to load the grid thus lowering the voltage or frequency. Disconnect switch 24 and Field disconnect switch 33 are closed. Computer 50 sends Motor generator directional control valve signal 70 to Motor generator directional control valve 36 to configure Motor Generator hydraulic motor pump 34 to be configured as a pump. It sends Pulse width modulator/field control signal 76 to Pulse width modulator 30 as necessary to excite Motor generator field 28 in accordance with the magnitude of the electric grid surplus power. It is possible that the surplus power is greater than can be accepted by the system of the present invention. In that case the excitation of Motor generator field 28 is set allow the system to accept the maximum level of power it is scaled to accept.

Motor generator 32 runs at its nominal speed and is capable of delivering the power available as surplus from Electric grid and Wind generator output 10 up to its design maximum power capability. It drives Motor Generator hydraulic motor pump 34 functioning as a pump to deliver fluid under pressure to Accumulator 49 and on to Flywheel directional control valve 42. The displacement of Hydraulic motor pump 34 is adjusted by Compute 50 to load Motor generator 32 to its nominal armature current.

The pressure level is below the threshold of Pressure relief valve 45

Accumulator 47 may be at any pressure that pressure having been established by the last system action.

The pressure within Accumulator 49 rises as a result of the fluid being pumped by Motor Generator hydraulic motor pump 34. Computer 50 senses the increased pressure via Accumulator pressure signal 66.

Computer 50 sends Flywheel directional control valve signal 64 to Flywheel directional control valve 42 to configure Flywheel hydraulic motor pump 44 to function as a motor. It adjusts the displacement of Flywheel hydraulic motor pump 44 to a position that causes the speed of Flywheel Hydraulic motor pump 44 to increase by an amount that causes the hydraulic pressure drop across Flywheel hydraulic motor pump 44 to be equal to the hydraulic pressure in Accumulator 49 which is the pressure that is being provided by Motor Generator hydraulic motor pump 34. As the speed of Flywheel hydraulic motor pump 44 increases it uses fluid derived from Motor Generator hydraulic motor pump 34 and Accumulator 49. The pressure in accumulator 49 declines causing the load on Motor generator 32 to decline. Computer 50 readjusts the excitation to Motor generator field 28 to increase Motor current 89 as measured by Current sensor 38, to the nominal required for the available surplus of the grid. The increased speed of the flywheel has now stored the surplus energy from the Electric grid and Wind generator output into the flywheel. The rate of energy transfer of energy from the Electric grid and wind generator output 10 into the flywheel is that of the power capability of Motor generator 32.

That action continues until either the status of Electric grid and Wind generator output 10 no longer has a surplus of power available as defined by the threshold established by the grid system operator or Flywheel 46 reaches its maximum speed as determined by Flywheel speed signal 60. In either event at that time Computer 50 places the system in Standby.

A condition could arise in which the status of the grid quickly changes from a surplus to a deficiency. In that case the system would not be placed in Standby but would immediately be configured into the flywheel-discharging mode. It would however go through the Standby configuration in reaching the discharging mode.

If frequency is the parameter under control, if Error signal 16 is less than minus Threshold signal 19 indicating a frequency that is too low, Computer 50 initiates a program to take action to provide power to the Electric grid and wind generator output 10 thus increasing its frequency.

If voltage is the parameter under control, if Error signal 16 is less than minus Threshold signal 19 indicating a voltage that is too low, Computer 50 initiates a program to take action to provide power to the grid thus increasing the voltage

The level of deficiency of the grid is presented to Computer 50. Electric rid and wind generator output status signal 84 derived from Signal transformer 48 defines the level of power deficiency. When that level of deficiency of the grid exceeds the threshold established by the grid system operator the Flywheel discharging mode is established.

It is necessary for the current in Motor generator 32 to reverse direction when changing from functioning as a motor to functioning as a generator. To do that it must first fall to zero. Because of the inductance of Motor generator 32, to stop a current flow immediately would cause an inductive voltage spike that could damage the Motor generator. Accordingly in order to prevent that damage from occurring Computer 50 uses a zero current crossing detecting sensing program to determine when the current in each phase of the three phase current reaches zero. As the current in each phase reaches zero, each section of Disconnect switch 24 and Field disconnect switch 33 are opened. Within the course of one cycle of the 3-phase current all three switch components of each switch will be open and the current in Motor Generator 32 falls safely to zero.

Computer 59 sends Flywheel directional control valve 42 Flywheel directional control valve signal 64 to cause Flywheel hydraulic motor pump 44 to function as a pump. Using Flywheel motor pump displacement signal 62 it adjusts the displacement of flywheel hydraulic its pressure. Computer 50, using Accumulator pressure signal 74 allows the pressure in Accumulator 49 to rise to typical nominal system pressure. Thereafter computer 50 adjusts the displacement of Flywheel motor pump 44 as necessary to nominal maintain system pressure in Accumulator 49.

Computer 50 sends Motor generator directional control valve signal 70 to Motor generator directional control valve 36 to cause Motor generator hydraulic motor pump 34 to function as a motor. Because of residual magnetism in Motor generator 32, voltage is developed by Motor generator 32. Using Field disconnect switch signal 88, Computer 50 closes Field disconnect switch 33. Current fed Motor generator field 28 establishes a controllable magnetic field in Motor generator 32. Using Pulse width modulator/field control signal 76 Computer 50 adjusts the current flow to Motor generator field 28 until the output voltage of Motor generator 32 is equal to that of Electric grid and Wind generator output 10 as shown by Electric grid and wind generator output status signal 84.

Using Motor generator motor pump displacement signal 72, Computer 50 adjusts the displacement of Motor generator hydraulic motor pump until the speed of Motor generator 32, functioning as a generator has an output frequency as shown by Motor generator voltage and frequency signal 74 to be at the same frequency as that of Electric grid and Wind generator output 10. Using Disconnect switch control signal 82, Computer 50 closes all three phases of Disconnect switch 24. Motor generator 34 is now connected to Electric grid and Wind generator output 10, but no power is being transferred. Using Pulse width modulator/field control signal 76, Computer 50 increases the excitation of Motor generator field 28. That raises the output voltage of Motor generator 32 causing current to flow into Electric rid and Wind generator output 10. Using Pulse width modulator/field control signal 76, Computer 50 increases the excitation of Motor generator field 28 until the armature current as measured by current sensor 38 and whose value is transmitted as Motor current signal 89 to Computer 50 has reached its nominal value for the existing voltage. Using Motor generator motor pimp displacement signal 72, Computer 50 continues to adjust the output frequency of Motor generator 32 to match the frequency of Electric grid and Wind generator output 10. Power is now being transferred into Electric grid and Wind generator output at the maximum power capability of Motor generator 32.

As power is delivered the pressure in Accumulator 49 declines. Using Flywheel motor pump displacement signal 62, Computer 50 continues to adjust the displacement of Flywheel hydraulic motor pump 44 as necessary maintain nominal system pressure in Accumulator 49. As energy is taken from the flywheel, the speed of Flywheel 46 declines and continues to decline as power continues to be withdrawn until it reaches a lower preset limit as sensed by Flywheel speed signal 60. At that time Computer 50 configures the system into standby mode waiting for the next charging cycle.

Had the additional power fed to the Electric grid and Wind generator output reduced the deficiency to a value below the threshold defined by the grid system operator, at that time Computer 50 would place the system into standby mode.

A flywheel being exposed to continuous stresses may structurally fail. As it runs in normal use vibrations are set up in the mechanics of the flywheel, its bearings and its mount. If the flywheel is functioning normally and has suffered no mechanical degradation, its vibration signature consists of a multitude of vibration frequencies that is sensed by Vibration sensors 40. Computer 50 is programmed to accept the normal vibration signature. Upon an imminent structural failure of Flywheel 46 there is a physical shift in the structure of Flywheel 46. Imminent failure typically occurs only when Flywheel 46 is at or near top speed and is therefore exposed to maximum stresses. As that shift occurs in Flywheel 46, the vibration signature as sensed by Vibration sensor 40 and transmitted to Computer 50 by Vibration signal 80, is sufficiently altered to create failure identification in Computer 50. Vibration sensor 40 is a dual redundant sensor on each bearing housing and Vibration signal 80 is a dual redundant signal emanating from each Vibration sensor 40. Dual redundant vibration signal 80 is fed to two independent channels of Computer 50 each of which continuously runs a self test. All the signals are continuously compared to the normal vibration signature as shown by Vibration sensors 40 and Vibration signal 80. If in any of the data processing a vibration signature difference occurs, computer 50 immediately initiates a shut down procedure. Computer 50 immediately configures Motor generator hydraulic motor pump 34 to the standby mode. It increases the displacement of Flywheel hydraulic motor pump 44 to a maximum allowable for its existing rotational speed and disables the control loop that matches the pressure drop of Flywheel hydraulic motor pump 44 to that of Accumulator 49. Pressure quickly builds in Accumulator 49 until it reaches the pressure relief setting of Pressure relief valve 45. Pressure relief valve 45 opens allowing fluid flow to the storage tank thus beginning to dissipate the energy stored in Flywheel 46. Flywheel 46 immediately begins to slow and as it does lowers the stress that caused the imminent failure. No ultimate failure will occur since the system is no longer functional and the flywheel stops. When the flywheel has stopped a failure signal is communicated to the system operator by communications means not part of this invention.

In another embodiment, Flow Control valves could manage the speed and power output of fixed displacement hydraulic motor pumps replacing the variable displacement hydraulic motor pumps of the preferred embodiment.

In still another embodiment, the system could acquire energy from any available electrical source, store it until needed and deliver it either to the same electrical source if it became an electrical sink or to an entirely independent electrical sink.

In still another embodiment, the Ac motor generator could be a squirrel cage induction motor/generator with appropriate controls.

### CONCLUSIONS RAMIFICATIONS AND SCOPE

Many advantages over existing energy storage systems become apparent.

Electrochemical storage systems are currently most heavily used because of the inability of industry to build a safe and cost effective flywheel system. Billions of dollars have been spent attempting to develop a battery system that correctly meets the needs of grid level energy storage. To date there has been only slight improvement in performance and no improvement in the cost of grid level battery storage systems. Many operating nuances have been tried such as doubling the number of bakeries needed to reduce the depth of cycle of the system In the end that only reduced the amount of time before they must be replaced. Many types of batteries have been tried and they all suffer the same deficiencies. They can be discharged quickly but must be recharged slowly. While they store a large amount of energy for their short life time and high replacement cost, their ability to support great fluctuations in voltage and frequency of the grid is limited. The flywheel system of the present invention overcomes those difficulties.

In other flywheel systems the flywheel has been driven by electrical power. A flywheel is an inertial load that electrical motors are unable to efficiently handle. Enormous heating results that requires ancillary refrigeration. Additionally, electrical drive requires the ability to accommodate the variable frequency derived from the flywheel. The system of the present invention directly couples to the grid without the need for ancillary matching electronics.

While the above description contains many specifics these should not be construed as limitations on the scope of the invention but rather as an exemplification of one of several embodiments thereof. Many variations are possible. Accordingly the scope of the invention should be determined by the appended claims and their legal equivalents. It will be readily apparent to those skilled in the art that various changes may be made without departing from the scope of the invention.

I claim:

1. A hydraulically driven flywheel energy storage system using inertial energy storage to stabilize the voltage and frequency performance of the electric grid and the output of wind generated power, the system comprising:
(a) a central computer processor capable of processing input and output electrical signals through appropriate electronics to functional components of the system.
(b) an energy management system stored on and controlled by the computer processor which is adapted to acquire, store, process and disperse energy derived from and used by electrical, mechanical and hydraulic components of the system to stabilize the performance of the electrical grid or wind generated power.
© a flywheel structural monitoring program stored on and controlled by the computer processor which is adapted to identify and mitigate an eminent flywheel structural failure.
(d) an electrical motor generator controlled by the computer processor and which is adapted to process electrical energy directly from and into the electric grid or wind driven generator output.

2. The hydraulically driven flywheel energy storage system of claim 1 further comprising a program means adapted to allow the system operator to adjust the level of frequency or voltage control of the electric grid or wind generated power.

3. The hydraulically driven flywheel energy storage system of claim 1 wherein energy is acquired and processed from the electric grid or wind driven generator, the energy then being transmitted to a hydro pneumatic pressure sensing accumulator, one or more directional control valves and one or more hydraulic motor pumps to stabilize the performance of the electric grid or wind generated power.

4. The hydraulically driven flywheel energy storage system of claim 1 wherein energy is stored in the flywheel as inertial energy and processed into and out of the flywheel by the use of hydraulic motor pumps being directly connected to the flywheel.
